(19) United States
(12) Patent Application Publication
(10) Pub. No.: US 2015/0225170 A1
(43) Pub. Date: Aug. 13, 2015

(54) Transportable Container and Method for Collecting Recyclable Waste

(71) Applicant: APK ALUMINUM UND KUNSTSTOFFE AG, Merseburg (DE)

(72) Inventors: Bjorn Lindner, Aachen (DE); Wolfgang Lindner, Leipzig (DE); Ingo Lindner, Leipzig (DE)

(21) Appl. No.: 14/426,858

(22) PCT Filed: Sep. 5, 2013
(86) PCT No.: PCT/DE2013/000516

§ 371 Date: Apr. 13, 2015

(30) Foreign Application Priority Data
Sep. 9, 2012 (DE) 10 2012 017 736.4

(51) Int. Cl. B65F 1/00; B65F 1/14

(52) U.S. Cl. CPC B65F 1/002; B65F 1/1646; B65F 2220/00

(57) ABSTRACT

The invention relates to a method and a transportable container for collecting recyclable waste which includes a receiving chamber with an opening which opens from outside into the receiving chamber. The waste can be introduced into the receiving chamber through the opening. Pressure equalizing means are provided for the container which makes it possible for air to escape from the receiving chamber to the surroundings thereof in the case of a closed opening when the container is compressed from outside.

The invention relates to a transportable container for collecting recyclable waste according to the preamble of claim 1 and to a method for such according to claim 16.

The field of waste management has available a multiplicity of different containers with which it is possible to collect, and possibly return, waste. In the simplest case, such containers are of a structurally rigid design and serve for accommodating flexible bags or sacks, into which the waste is introduced.

Structurally rigid containers are provided usually for stationary use. If a bag has been filled with waste, then it can be exchanged for a new bag. The handling of filled garbage bags is disadvantageous on account of the low inherent stability of said bags and the risk of them tearing open.

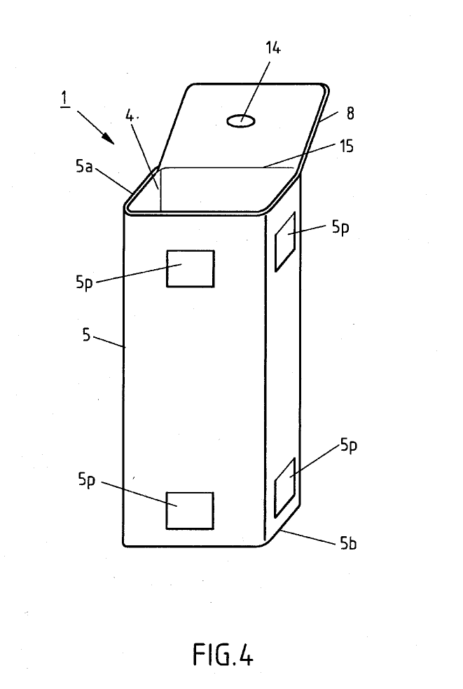

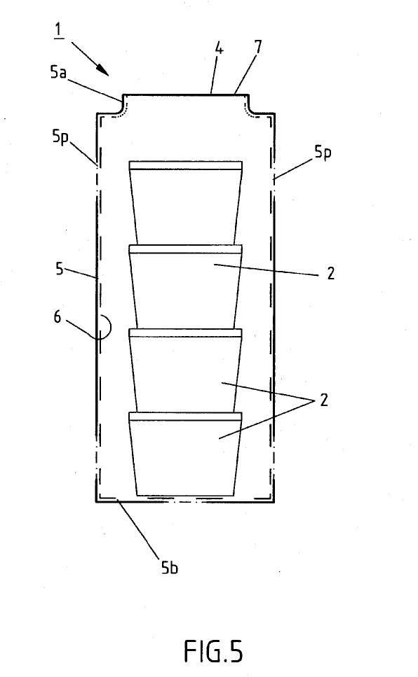

U.S. Pat. No. 5,440,978 discloses a waste container for used paper, the container accommodating an expandable net of which the opening is made to coincide with an upper opening of the container. An upper net region, which is adjacent to the opening, contains a cylindrical collecting region, in which a piston-like body, which is formed on an underside of the container lid, engages when the lid is closed. Opening and closing operations of the lid can be actuated via a foot pedal. When used paper is introduced into the cylindrical collecting region, with the lid open, renewed closure of the lid causes the used paper to be compacted in the downward direction, and moved into the expandable net, by the piston-like body. A gradual operation of the net being filled with used paper is depicted, in particular, in FIGS. 4 and 5. The refuse container according to U.S. Pat. No. 5,440,978 is provided for stationary use. Correspondingly, said refuse container cannot be classified as “transportable”, nor is its outer housing (“container section 12”) provided for being compressed or subjected to a force, and pressed together, from the outside.

It is conventionally also known to have waste containers which are returned, or passed on for further utilization, together with the waste accommodated in them. Such a single-use waste container is known, for example, from DE 100 32 727 A1, which can be used to collect in particular also liquid or partially liquid waste. A further single-use container is known from U.S. Pat. No. 5,860,555, this being used to mail used water cartridges back to the manufacturer. In the case of these two examples mentioned, accordingly, the waste containers are a constituent part of the recycling system and are passed on for further utilization together with the waste located in them.

U.S. Pat. No. 6,135,637 discloses a waste sack which has air slits and is formed from a flexible plastics sheet material. The aforementioned air slits are designed in the form of a perforation arrangement or as a predetermined breaking point within the plastics sheet material, as result of which, when the waste sack is compressed and the internal pressure increases accordingly, the air slits break open and air from the waste sack can pass outward, through the broken-open air slits, to the surroundings.

DE 35 04 475 A1 discloses a garbage sack consisting of a plastics sheet material, wherein the plastics sheet material is provided with a plurality of venting holes, and therefore it is possible for the garbage sack to be compacted together with its contents without the garbage sack being torn in the process on account of excess air pressure. The plurality of venting holes are arranged, for example, along a rectilinear line or helically along the circumference of the garbage sack.

DE 92 11 719 U1 discloses a sack which is intended for collecting paper waste and comprises an enclosure formed from tear-resistant paper. An upper opening of the enclosure can be closed by a tie, which is likewise formed from paper material and is fastened on the enclosure. It is also the case that the enclosure is provided, at least in a sub-region, with a plurality of perforation holes which, in the case of the sack being compressed, ensure that air escapes and thus effectively prevents the sack from tearing open or bursting in an uncontrolled manner.

GB 2 421 171 A discloses a structurally rigid container for collecting recyclable waste. The container is of rectangular design and has, in its walls, a plurality of windows or through-openings. An interior of the container is lined with a liner or a net, wherein the recyclable waste is introduced into this net. If the net has been filled with recyclable waste, it is retained, and/or stabilized, by the inner wall of the container. The container according to GB 2 421 171 A is not provided for its accommodating space to be subjected to a force or pressed together from the outside.

For some time now, it has become established practice to use separate garbage collection, in which recyclable waste containing recyclables in the form of plastics materials, metal or other composites, is collected separately from normal household garbage. This method of collecting recyclable waste is known in Germany by the practice of using the so-called “yellow sack”. The recyclable waste, which is collected using the yellow sack, is then delivered to recycling plants or sorting plants, in which the contents of the yellow sack are further separated from one another and/or sorted according to material type, size, etc.

Recyclable waste, which, as explained above, is collected in Germany inter alia using the yellow sack, may also contain small articles. Such small particles also include, for example, used coffee capsules or tea capsules, which may consist of aluminum and/or plastics material. The disadvantage of such small particles is that these may not be detected correctly, on account of their small dimensions, in the recycling or sorting plants, and therefore they pass erroneously into other recyclable-material fractions and then contaminate these.

In Germany, the yellow sacks are usually collected by garbage trucks belonging to the municipal garbage-disposal department. The garbage accommodated in the garbage trucks is pressed together or pre-compressed in a known way, in order to increase the capacity of the garbage truck. This means that the contents of the yellow sacks are compressed and pressed together to a pronounced extent here. If there are small recycling particles contained in a closed container, then the aforementioned operation of compressing the garbage holds the risk of these containers bursting open and of the small particles located in them falling out. The problem explained above, of these small particles then possibly not being correctly detected and sorted in the sorting plants therefore continues for the case of damaged or burst-open containers.

It is an object of the invention to create a transportable container, and a method for collecting recyclable waste, in which there is an improvement in the stability of the container against the action of force from the outside and in the efficiency of collecting the recyclable waste.

This object is achieved by a transportable container having the features of claim 1 and by a method having the features of claim 16. Advantageous developments of the invention are defined in the dependent claims.

A transportable container according to the present invention is suitable for collecting recyclable waste and comprises an accommodating space with at least one opening, which opens out into the accommodating space from the outside. Accordingly, the accommodating space can be filled with recyclable waste from the outside. The opening of the accommodating space can be closed. The container further comprises pressure-equalizing means which, when the opening is closed, allow air to escape out of the accommodating space to its surroundings, in particular when the container is pressed together, or subjected to a force, from the outside. The container has an outer casing, which encloses the accommodating space. It is possible here for the accommodating space to be formed directly by the interior of the outer casing. The opening, which opens out into the accommodating space, is formed, accordingly, in a wall of the outer casing.

The invention is based on the significant finding that the pressure-equalizing means can reduce, if not rule out altogether, the risk of transportable containers, in which recyclable waste is accommodated, bursting open in an uncontrolled manner when being pressed together in a garbage press or the like. The pressure-equalizing means allow pressure equalization between the accommodating space, or the interior of the outer casing, and the surroundings thereof when the container is compressed or subjected to a force from the outside. This pressure equalization therefore prevents the outer casing from bursting open in an uncontrolled manner and thus the waste from falling out of the accommodating space.

The container according to the invention serves as a collecting container for recyclable waste, wherein the container is returned to the waste-recycling process together with the waste accommodated in it. Up to a selected stage in the process of recovering recyclables, the container ensures that the recyclable waste remains in a bundled state in the container and does not go astray at any time during the process. It is expediently the case that the waste which is filled into the accommodating space of the container contains, at least in part, the same recyclables as are also a constituent part of the container. As a result, the container according to the invention improves the efficiency of collecting and/or recovering recyclable waste.

According to a further configuration of the invention, a sack-like bag with an opening may be provided within the outer casing. The accommodating space here is formed by the bag itself, wherein the opening of the bag coincides with the opening of the accommodating space. Pressure equalization by way of the pressure-equalizing means can take place here between the accommodating space, i.e. the interior of the bag, and its surroundings, i.e. at least the interior of the outer casing, that is to say when the outer casing is produced from a stable material and is of gas-tight configuration in relation to the surroundings. It is optionally possible for the outer casing likewise to be provided with the pressure-equalizing means (e.g. venting hole, perforation arrangement or the like), and therefore pressure equalization also takes place between the interior of the bag and the surroundings of the outer casing. In other words, air can pass outwards from the bag, via the interior of the outer casing, to the surroundings by way of the pressure-equalizing means.

In the case of the embodiment mentioned above, which provides an accommodating space in the form of the bag within the outer casing, recyclable waste is filled into the interior of the bag through the opening. Accordingly, the bag is always located between the particles of waste and the inner wall of the outer casing. The bag has the purpose of additionally keeping the waste particles in a bundled state, or keeping them together, in it. If the outer casing of the container should burst open, the bag prevents the waste particles from falling out of the hole produced in the outer casing. In other words, the sack-like bag forms an additional loss-prevention means for the waste particles when the outer casing of the container is damaged.

The bag is expediently designed in the form of a sheet material or of a net and is preferably produced from plastics material. A bag in the form of a net may be produced from polypropylene (PP), wherein the PP filaments may be pre-stretched, in order for the tensile strength of such a net to be increased.

The pressure-equalizing means may be configured in many different ways, that is to say in the form of a pressure-relief valve, which is in fluid connection with the accommodating space, in the form of a perforation arrangement or in the form of at least one venting hole of the accommodating space in the form of the outer casing, or in the form of a perforation arrangement or at least one venting hole of the accommodating space in the form of the sack-like bag. The aforementioned perforation arrangements of the outer casing or of the bag may be designed in the form of predetermined breaking points, by way of which the outer casing or bag bursts open in a specific manner if the excess pressure within the accommodating space exceeds a predetermined value when the container is being pressed together. In addition, or as an alternative, to the perforation arrangements, pressure equalization is also possible by way of at least one venting hole formed in the bag or the outer casing. It is always the case that the perforation arrangement or the venting hole in the bag or outer casing is smaller than the dimensions of the waste particles accommodated in the accommodating space, and therefore these particles cannot accidentally fall out of the accommodating space.

Within the context of the present invention, the pressure-equalizing means can be understood to the effect that, in the case of the container being subjected to an external force, the pressure-equalizing means allow pressure equalization between the accommodating space and its surroundings in a very short period of time, for example within a few seconds or even fractions of seconds. Accordingly, the aforementioned pressure-equalizing means, for example pressure-relief valve, the perforation arrangement(s) or venting holes of the bag or outer casing are dimensioned such that the quantity of air which can pass out in the direction of the surroundings is large enough to prevent the outer casing or the bag from bursting open.

In an advantageous development of the invention, the sack-like bag in the accommodating space is designed in the form of a liner and is fastened, for example by adhesive bonding, riveting or the like, at at least one point on the inner wall of the outer casing. The bag is expediently in large-surface contact with the inner wall of the outer casing, and therefore the inner wall is essentially fully lined by the bag. As result, the inner volume of the bag corresponds essentially to the interior of the outer casing and thus ensures a large container capacity for the recyclable waste.

The aforementioned fastening of the bag on the inner wall of the outer casing also has the advantage that the bag with its contents, even in the event of the outer casing being partially damaged, remains connected to the container. This means that, during the operation of sorting or separating the garbage, the waste particles, which are accommodated within the bag, remain connected to the container for the longest period of time possible, and this allows the garbage to be sorted by type up until predetermined separation of recyclables has been achieved.

The opening which opens out into the accommodating space is dimensioned sufficiently large for it to be possible for the accommodating space to be filled, through said opening, with recyclable waste, in particular in the form of solid bodies. Such solid bodies here include, for example, used coffee capsules or tea capsules. The accommodating space is configured in adaptation to such recyclable waste such that these solid bodies can be stacked one above the other, and/or arranged one beside the other, within the accommodating space.

The capacity of the container can advantageously be increased further in that a plurality of chambers are formed within the accommodating space. As seen along a longitudinal extent of the container, these chambers are formed in each case along the longitudinal extent and parallel to one another. As a result of the plurality of chambers, the individual waste particles, for example used coffee or tea capsules, are stacked one above the other in the respective chambers. The chambers here have their diameter adapted to the dimensions of the capsule(s).

In an advantageous development of the invention, the opening of the accommodating space can be closed, e.g. by a lid. In addition, and/or as an alternative, said opening can be narrowed in its through-passage region, e.g. by being tied closed, so that it is not possible for waste particles to fall out of the accommodating space. The last-mentioned variant is suitable, in particular, for the case where the accommodating space is designed in the form of the bag accommodated within the outer casing of the container.

It is advantageously possible for the opening to the accommodating space to be closed manually by a closure element in the form of a lid, wherein an operator does not require any further auxiliary means for this purpose. The lid here can be fastened on the opening by means of a screw closure or rotary closure. A moment which is sufficient for screwing tight, or tightening, the lid can be indicated, for example, by a “clicking” noise, and therefore the operator is given acoustic feedback to the effect that the opening has been closed properly and securely by the lid. It is advantageous, in practice, if the lid is connected to the container in such a manner as to prevent loss, and therefore it does not go astray, and is always to hand, when it is not fitted on the opening.

In particular for the case where a plurality of chambers are formed in the accommodating space, the opening(s) which opens or open out into the accommodating space are suitably closed by a lid which interacts in a form-fitting manner with a peripheral region on an upper end side of the outer casing, for example via latching by means of an undercut. It is advantageous here if the lid is connected to, or articulated on, the outer casing via a film hinge. Such a film hinge can be produced inexpensively and is of reliable design in practice for repeated actuation.

In an advantageous development of the invention, the container is in the form of an elongate cuboid and has a volume between 500 cm³ and 3000 cm³. In a further preferred embodiment, the cuboidal container has a volume between 1000 cm³ and 2000 cm³. The volume of the container therefore corresponds to that of conventional milk cartons known, for example, by the brand name Tetrapak®. This facilitates handling of the container according to the invention during processing in a sorting plant.

In an advantageous development of the invention, it is possible for the container, prior to being used, i.e. prior to the accommodating space being filled correspondingly with recyclable waste, to be folded together, for example along its longitudinal axis. This allows the container, prior to actually being used, to be made suitably smaller in dimension in order, in this state, to be delivered to consumers, or the households, and brought into circulation.

The container according to the invention is distinguished in that it can be produced in a manner similar to the containers which are known on the market, for example, from the Tetrapak® brand, that is to say in respect of material type and outer dimensions. This gives rise firstly to the advantage that, for producing the container according to the invention, use can be made of already installed machinery, without any need for new investment. A further advantage is that, on account of the container having similar dimensions to conventional packs, such as milk cartons, juice cartons and the like, the container can be readily processed in sorting plants.

Suitable detection of the container during processing within a sorting plant can take place by way of optical systems and/or manual intervention of operating staff.

An essential aspect of the invention and of the method on which the invention is based consists in that the recyclable waste introduced into the container comprises, at least in part, the same recyclables as are also a constituent part of the container. This means that the container and the waste particles accommodated in it form a homogenous or homogenized group of recyclables which, together, are passed on for further utilization. As already explained above, this homogenized group of recyclables, in the form of the container with the waste particles contained in it, is suitably detected in sorting plants by optical systems or the like.

As far as further advantageous configurations of the invention are concerned, reference is made to the dependent claims and to the following description of advantageous exemplary embodiments, with reference to the accompanying drawing, in which:

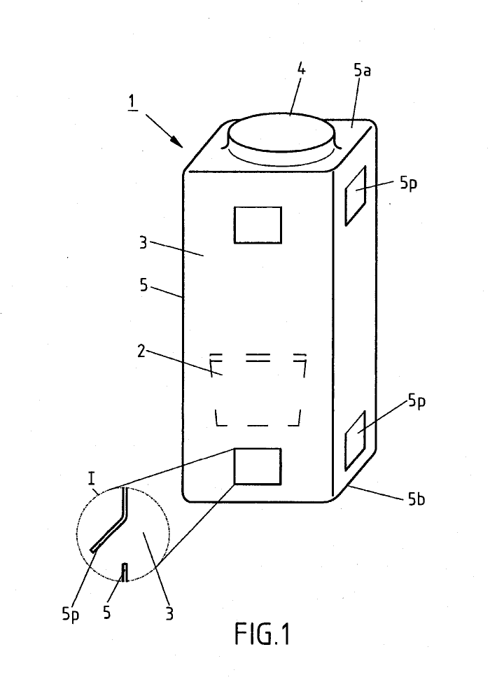

FIG. 1 shows a perspective view of a first embodiment of a container according to the invention;

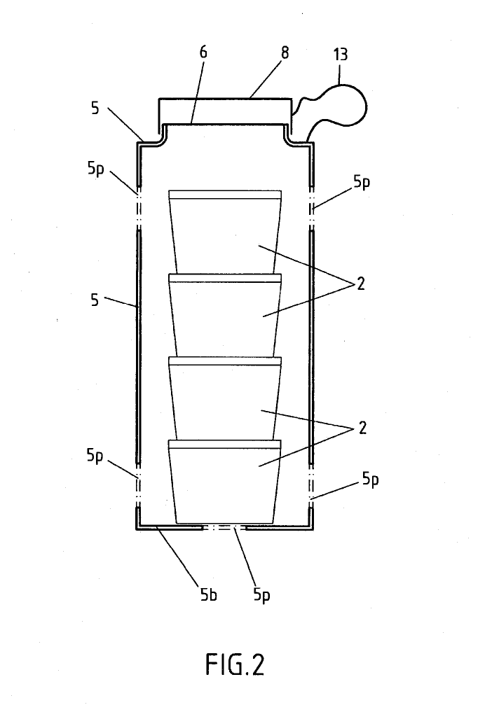

FIG. 2 shows a longitudinal-section view of the container from FIG. 1;

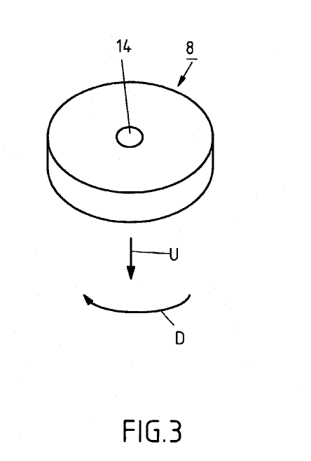

FIG. 3 shows a perspective view of a lid, for use with the container from FIG. 1;

FIG. 4 shows a perspective view of a second embodiment of a container according to the invention;

FIG. 5 shows a longitudinal cross-sectional view through a container according to a further embodiment, analogous to the illustration of FIG. 2;

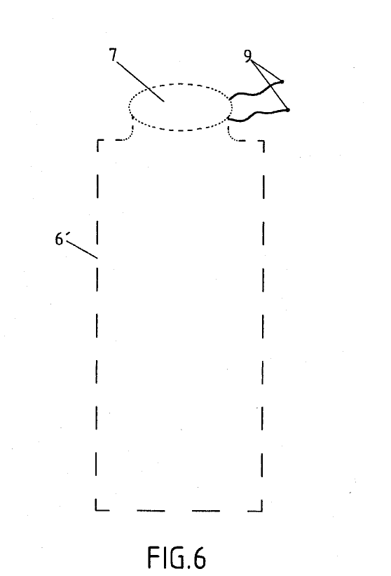

FIG. 6 shows a simplified side view of a sack-like bag with a net structure, the bag being provided for use with the container from FIG. 5;

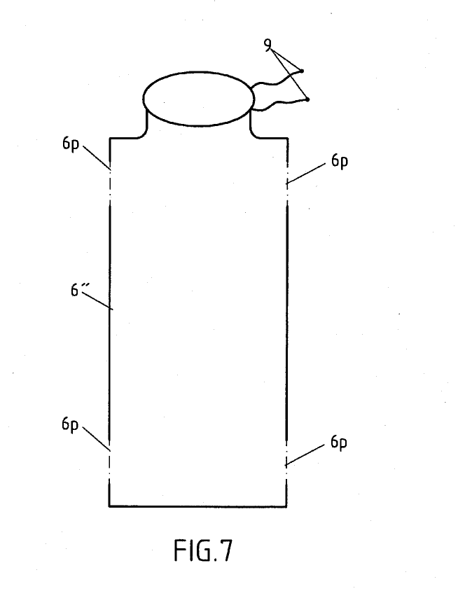

FIG. 7 shows a simplified side view of a further embodiment of a sack-like bag which is produced by a plastic sheet material with at least one perforation arrangement and is provided for use with the container from FIG. 5;

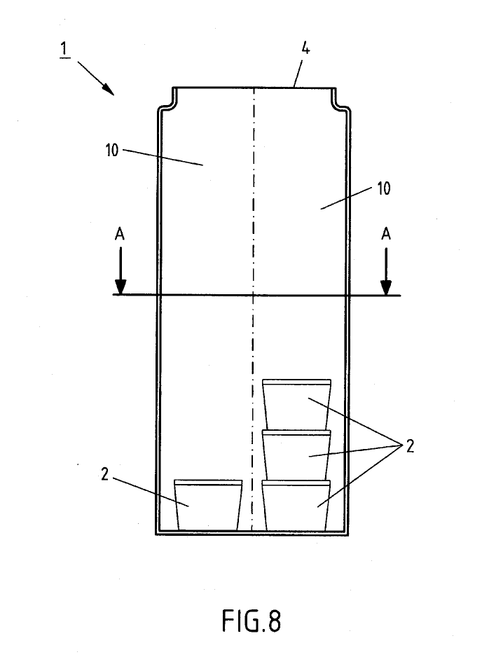

FIG. 8 shows a simplified longitudinal cross-sectional view through a further embodiment of the container according to the invention, a plurality of chambers being formed along the longitudinal extent of the container;

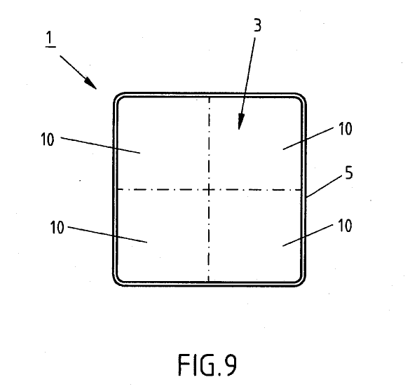

FIG. 9 shows a cross-sectional view through the container from FIG. 8, the section being taken along line A-A shown in FIG. 8; and

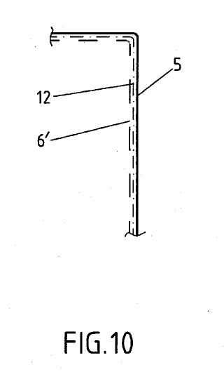

FIG. 10 shows a sectional view through the wall region of an outer casing of the container according to the invention.

FIGS. 1-3 show a first embodiment of a container 1 according to the invention.

FIG. 1 shows a perspective view of the container 1. Dashed lines 2 indicate, in simplified form, recyclable waste, which is accommodated in an accommodating space 3. The accommodating space 3 has an opening 4, through which the waste 2 can be filled into the accommodating space 3. In this respect, it is, of course, the case that a diameter of the opening 4 is adapted to the outer dimensions of said waste 2 and is selected, accordingly, to be sufficiently large.

In the case of the embodiment shown in FIG. 1, the accommodating space 3 is formed by an outer casing 5. The opening 4, which opens out into the accommodating space 3, is formed on an upper end side 5a of the outer casing 5.

The container 1 also comprises so-called pressure-equalizing means. In the case of the embodiment illustrated in FIG. 1, these pressure-equalizing means are designed in the form of a perforation arrangement 5p in the outer casing 5, shown by way of example in FIG. 1, at two locations on each side surface of the outer casing 5, that is to say adjacent to the upper end side 5a and to a lower end side 5b, which is located opposite the upper end side 5a. The meaning and the functioning of the pressure-equalizing means will also be explained in detail hereinbelow.

FIG. 2 shows a longitudinal-section view of the container 1 from FIG. 1. The pressure-equalizing means 5p explained above are illustrated here in the form of a chain-dotted line in the wall regions of the outer casing 5.

Recyclable waste 2 is accommodated in the accommodating space 3. FIG. 2 shows this waste 2 in a simplified manner in the form of used coffee or tea capsules, in this case four capsules being stacked one above the other. It can also be seen that an external diameter of said capsules 2 is slightly smaller than the internal diameter of the opening 4, and therefore the capsules 2 can be introduced into the accommodating space 3 without tilting or the like. As a departure from the used capsules 2 shown, it is, of course, the case that the accommodating space 3 can also be filled with other types of recyclable waste, preferably in the form of solid bodies.

Also provided is a lid 8, which can be fitted on the opening 4 from above in order to close the accommodating space 3 in a suitable manner. FIG. 5 depicts a simplified perspective view of said lid 8. The arrow U shows the direction in which the lid 8 is positioned on the opening 4. The lid 8 may be provided with a screw thread. FIG. 3 uses the arrow D to depict the direction of rotation in which the lid 8 can be screwed onto the opening 4 on the upper end side 5a of the outer casing 5. As far as its screw connection is concerned, the lid 8 is designed to be stable enough for the lid 8 not to burst off from the opening 4 when the container 1 is pressed together.

FIG. 2 shows a loss-prevention means 13 in the form of a strap or the like, which can fasten the lid 8 on the container 1, e.g. on the upper end side 5a. The strap 13 has the function of ensuring that the lid 8, rather than going astray from the container 1, is always at hand when it is not screwed onto the opening 4. This means that the accommodating space 3 of the container 1 can always be closed by the lid 8. In addition, or as an alternative, to the strap 13, it is possible to provide e.g. on an outer wall of the outer casing 5, a holder, to which the lid 8 can be connected in a releasable manner (e.g. by clipping) when it is not fitted on the opening 4.

Looking at FIGS. 1 and 2 together shows that the container 1 is designed in the form of an elongate cuboid which, on its upper end side 5a, is provided with an opening 4 through which the accommodating space 3 can be filled with recyclable waste 2.

The function of the aforementioned pressure-equalizing means will be explained hereinbelow.

Once the container 1 has been completely filled with recyclable waste 2 and the accommodating space 3 has been closed by the lid 8, the container 1 is collected, for example via the “yellow sack” collecting system, and passed on for waste recycling. It may be the case here that the container 1 is subjected, for example by a garbage press or the like, to considerable forces from the outside and is deformed correspondingly inwards into the accommodating space 3. As a result, the air contained in the accommodating space 3 is compressed to a pronounced extent. In order to avoid the container 1 bursting open completely when it is pressed together, the pressure-equalizing means in the form of the perforated wall regions 5p are provided, wherein said perforated regions 5p burst open outwards in a specific or controlled manner from a certain internal pressure within the accommodating space 3. The enlarged sub-view I in FIG. 1 shows, in simplified form, a perforated region 5p of the outer casing 5 once the container has burst open, wherein the aforementioned excess pressure within the accommodating space 3 has caused the perforated region 5p to swing open in the outward direction. This gives rise to an opening which connects the accommodating space 3 to the surroundings, and therefore pressure equalization can take place in a very short period of time. It can also be seen that the perforated region 5p is selected to be significantly smaller than the outer dimensions of a coffee capsule 2. Accordingly, it is not possible for a used coffee capsule 2 which is adjacent to a broken-open perforated region 5p to fall out of the accommodating space 3. As a result, the waste 2, or the used capsules 2 shown in FIG. 2, thus remains/remain within the container 1 even when the latter is being pressed together from the outside.

The pressure-equalizing means may also comprise a pressure-relief valve 14, which is illustrated in simplified form in FIG. 3 and may be arranged in the lid 8. The pressure-relief valve 14 is designed such that it is possible, from a certain excess pressure within the accommodating space 3 for air to escape to the surroundings. The pressure-relief valve 14 may be provided in addition, or as an alternative, to the perforated wall regions 5p of the outer casing 5, wherein the pressure-relief valve 14 may be arranged either, as shown, in the lid 8 and/or also in the wall of the outer casing 5.

FIG. 4 shows a perspective view of a further embodiment of the container 1. In contrast to FIG. 1, the lid 8 of the embodiment according to FIG. 4 has one longitudinal side fitted, or articulated, on the upper end side 5a of the outer casing 5 via a film hinge 15. The illustration of FIG. 4 shows the lid 8 in the open state, when the opening 4 in the region of the upper end side 5 has been fully opened. In the closed state (not shown), the lid 8 fully engages around the peripheral regions of the upper end side 5a and is secured here in a form-fitting manner by engagement of an undercut. In the case of the embodiment according to FIG. 4, it is likewise possible for the lid 8 to be provided with a pressure-relief valve 14. Furthermore, the functioning of the container 1 according to the embodiment of FIG. 4 is identical to the container according to FIGS. 1-3, reference therefore being made to the latter so as to avoid repetition.

As far as the illustration in FIG. 1 is concerned, it should be noted that the lid 8, in order to simplify matters, has not been shown. As an alternative to the embodiments of FIGS. 1 and 4, it is also possible for the accommodating space 3 to be closed without use of a lid 8, e.g. by being tied closed or the like. As a result, the opening 4 is suitably narrowed so that it is not possible for waste located in the accommodating space 3 to fall out.

FIG. 5 shows a further embodiment of the container 1, namely in a longitudinal cross-sectional view similar to FIG. 2. In contrast to the latter, the embodiment of FIG. 5 additionally has a sack-like bag 6 of which the opening 7 is connected in sealing fashion to the upper end side 5a of the outer casing 5. FIG. 5 uses a dashed line to indicate the bag 6 in simplified form within the accommodating space 3. In the case of this embodiment, the accommodating space 3 is formed by the bag 6 accommodated within the outer casing.

Accordingly, the recyclable waste—in the form of the used capsules 2—is introduced within the bag 6 itself, that is to say through the opening 7, which coincides with the opening 4. The bag 6 is in surface contact with the inner wall of the outer casing 5, and is preferably adhesively bonded to said inner wall.

FIG. 6 illustrates, in simplified form, a side view of the sack-like bag 6 used in the container 1 from FIG. 5. The bag 6, according to this embodiment, is formed by a net 6′, which is produced from tensile-resistant filaments. The pressure-equalizing means are likewise realized for this net, namely by the interspaces which are automatically present between the respective filaments in the net. This means that, in the case of such a net 6′, a pressure equalization with the surroundings of the accommodating space 3 automatically takes place when the container 1 is compressed.

The aforementioned net 6′, which is used for the container 1 from FIG. 5, serves as a loss-prevention means for the capsules 2 introduced in the accommodating space 3. If the wall of the outer casing 5, as a result of being subjected to a force from the outside, should tear open at any point, then the net 6′ prevents any adjacent capsules 2 from falling out.

FIG. 6 indicates a tie 9 in the region of the opening 7 of the net 6′. The tie 9 can be used to tie closed the opening 7 of the net once the accommodating space 3 has been filled. This has the advantage that, in the event of the lid 8 bursting off from the opening 4 in an undesired manner, it is not possible for the capsules 2 to fall out of the accommodating space 3.

FIG. 7 shows a simplified side view of an alternative embodiment of the sack-like bag 12, namely in the form of a bag which is produced from a plastics sheet material 6″. Such a plastics-sheet-material bag 6″ can be used for the container 1 from FIG. 5 as an alternative to the net 6′. FIG. 7 uses arrows 6p to indicate, in simplified form, perforated regions of the bag 6″. These perforated regions 6p form pressure-equalizing means for the bag 6″ because, from a certain excess pressure within the bag 6″, said perforated regions 6p burst open in the outward direction and thus ensure pressure equalization with the surroundings. As an alternative, or in addition, to the perforated regions, it is also possible for the plastics-sheet-material bag 6″ to contain at least one venting hole (not shown), which ensures pressure equalization in relation to the surroundings in the manner explained.

It is essential, in the case of the embodiments according to FIGS. 5-7, for the pressure-equalizing means 6p to be provided at least in the bag 6, so that, when the container 1 is pressed together, the bag 6 does not burst open in an uncontrolled manner and is therefore destroyed. Instead, the air flows in a specific manner out of the bag 6 into the surroundings of the same. Pressure equalization of the accommodating space 3, which is designed in the form of a bag 6 (as a net 6′ or sheet-material bag 6″), with its surroundings should be understood as meaning that the air which escapes out of the bag 6 escapes first of all into the interior of the outer casing 5. It is also possible for the outer casing 5—in contrast to the illustration of FIG. 1—to be designed without pressure-equalizing means, e.g. perforation arrangements or venting holes. If the outer casing 3 is of stable-walled design, then this means that pressure equalization of the bag 6 can take place without the outer casing 5 bursting open in the process.

For the case, which is shown in FIG. 1, where the outer casing 5 also has a perforation arrangement 5p and/or a venting hole (not shown) to the surroundings, and the internal pressure within the outer casing 5 exceeds the predetermined value, the air then also flows out of the interior of the outer casing 5 into the surroundings of the container 1.

FIGS. 8 and 9 show a further embodiment of the container 1, namely in a longitudinal-sectional view in FIG. 8 and in a cross-sectional view in FIG. 9, said section being taken along line A-A shown in FIG. 8.

The embodiment according to FIGS. 8 and 9 is distinguished by a total of four chambers 10 which are formed, as part of the accommodating space 3, along the longitudinal axis of the container 1 and in each case parallel to one another within the container 1. The cross-sectional view of FIG. 9 shows that these four chambers 10 divide up the accommodating space 3 into four equal segments. Recyclable waste 2 can be introduced into each of the chambers 10 from the upper end side 5a. In the illustration of FIG. 8, this is illustrated, for example, by used capsules 2. In each of the chambers 10, the capsules 2 can be stacked one above the other. In order to simplify matters, the illustration of FIG. 8 shows just a few capsules. Of course, it is possible for the accommodating space 3 of the container 2 to be filled over its entire height with capsules 2 or similar recyclable waste.

Subdividing the accommodating space 3 with a plurality of chambers 10 means that waste particles, in the form of the capsules 2 in the example shown, are stacked one above the other in each of the chambers 10. This has the advantageous effect of these capsules 2 being accommodated in ordered fashion in the accommodating space 3, and this results in a greater capacity of the accommodating space 3.

As far as all the embodiments illustrated in the drawing are concerned, it should be pointed out that the container 1 and the capsules 2 introduced in it are not illustrated to scale in the drawing. The embodiments of the container 1 which are shown in the drawing merely show the principle by which for example used capsules can be introduced in the accommodating space 3 and pressure equalization functions between the accommodating space 3, or the bag 6, and the surroundings if the container 1 is pressed together from the outside.

The container 1 has its outer casing 5 based on cardboard, and it is therefore structurally rigid and can thus be positioned in an upright state. For example, FIG. 1 depicts that the lower end side 5b of the container 1 is designed in the form of a standing surface. It is thus possible for the container to be stood up in an upright and space-saving manner on its lower end side 5b.

FIG. 10 shows a sectional view of a sub-region of the outer casing 5 and depicts a possible construction of the outer casing 5. “11” designates cardboard packaging, which forms an essential part of the outer casing 5. “12” is used in FIG. 10 to indicate a further coating, which may be provided on an inner wall of the outer casing 5. This further coating 12 may consist, for example, of an aluminum foil, which is moisture-repellent and/or thermally insulating. For the example of used coffee capsules 2 introduced into the accommodating space 3, such an aluminum foil 12 has the advantage that water droplets which may adhere to the coffee capsules 2 do not soak through the cardboard packaging 16. Furthermore, the temperature of an outer wall of the outer casing 5 remains essentially unchanged if increased-temperature coffee capsules 2 come into contact with the inner wall of the outer casing 5.

Finally, FIG. 10 uses a dashed line to indicate the sack-like bag in the form of the net 6′, which has already been explained in detail with reference to FIGS. 5 and 6.

For the embodiments explained above, the container 1 according to the invention, in respect to its construction and material type, is extremely similar to conventional packs which are available on the market, for example, in the form of milk cartons, available inter alia under the brand name Tetrapak®. This ensures cost-effective production of the container 1 according to the invention.

Since the container 1 can be produced predominantly from the aforementioned cardboard packaging 11, it is itself likewise returned to the recycling process, wherein it is treated in the same way as, or in a manner similar to, milk cartons or the like, in order to recover the cellulose on which the packaging is based. If the container 1 also incorporates materials other than paper, e.g. plastics materials or aluminum, then these materials are separated from the cardboard packaging in a known manner in the sorting-plant separating process and passed on for further, single-type utilization.

1. A transportable container for collecting recyclable waste, comprising
an accommodating space with at least one closable opening, which opens out into the accommodating space from the outside,
characterized by
the provision of an outer casing which encloses the accommodating space, and
pressure-equalizing means which allows air to escape out of the accommodating space to its surroundings when the opening is closed and the container is pressed together or subjected to a force from the outside.

2. The container as claimed in claim 1, including a sack-like bag with an opening, the bag is located with the outer casing, the accommodating space is formed by the bag.

3. The container as claimed in claim 2, characterized in that the bag is designed in the form of a liner which is fastened at at least one point on the inner wall of the outer casing.

4. The container as claimed in claim 3, characterized in that the bag is designed as sheet material or in the form of a net.

5. The container as claimed in claim 1, characterized in that the pressure-equalizing means are designed in the form of a pressure-relief valve which is in fluid connection with the accommodating space the in the form of an arrangement selected form the group consisting of 1) a perforation arrangement in the outer casing, or at least one venting hole in the outer casing.

6. The container as defined in claim 1, characterized in that the opening is dimensioned sufficiently large for it to be possible for the accommodating space to be filled with recyclable waste in the form of solid bodies.

7. The container as defined in claim 1, characterized in that the accommodating space can be closed at its opening by a lid, by a tie, or combinations thereof.

8. The container as claimed in claim 7, characterized in that the lid can be connected to the container in such a manner as to prevent detachment of the lid from the container when the lid is not fitted on the opening.

9. The container as claimed in claim 7, characterized in that the lid can be fitted on the opening by a screw closure or rotary closure.

10. The container as claimed in claim 8, characterized in that the lid is of elastic design and can be latched over an undercut by way of a peripheral region of the opening.

11. The container as defined in claim 1, characterized in that the accommodating space contains a plurality of chambers which can be filled via the opening, the chambers are formed within the accommodating space along a longitudinal extent of the container and parallel to one another.

12. The container as claimed in claim 11, characterized in that four chambers are formed in the accommodating space, the four chambers as seen in a cross section in a direction orthogonal to the longitudinal axis of the container form uniformly spaced-apart quadrants.

13. The container as defined in claim 1, characterized in that the container is in the form of an elongate cuboid which has a volume between 500 cm³ and 3000 cm³.

14. The container as defined in claim 1, characterized in that the outer casing is based on cardboard.

15. The container as defined in claim 1, characterized in that the outer casing is produced in one piece, prior to the container being used and the accommodating space being filled correspondingly with recyclable waste, the outer casing can be folded in particular along its longitudinal axis.

16. (canceled)

17. The container as claimed in claim 3, wherein the bag is in surface contact with the inner wall of the outer casing.

18. The container as claimed in claim 3, wherein the bag essentially fully lines the inner wall of the outer casing.

19. The container as claimed in claim 4, wherein the bag is produced from a plastic material.

20. The container as claimed in claim 2, characterized in that the pressure-equalizing means are designed in the form of a pressure-relief valve which is in fluid connection with the accommodating space in the form of an arrangement selected from the group consisting of 1) a perforation arrangement in the bag, or 2) at least one venting hole in the bag.

21. The container as claimed in claim 5, wherein the perforation arrangement is designed in the form of a predetermined breaking point and opens or ruptures from a certain excess pressure within the accommodating space.

22. The container as claimed in claim 20, wherein the perforation arrangement is designed in the form of a predetermined breaking point and opens or ruptures from a certain excess pressure within the accommodating space.

23. The container as claimed in claim 14, wherein the outer casing on its inside and/or outside has a further coating in the form of an aluminum foil which is moisture-repellent, thermally insulating, or combinations thereof.
